(19) United States
(12) Patent Application Publication
(10) Pub. No.: US 2004/0213100 A1
(43) Pub. Date: Oct. 28, 2004

(54) Method and apparatus for head positioning with disturbance compensation in a disk drive

(75) Inventor: Masafumi Iwashiro, Ome-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/792,796

(22) Filed: Mar. 5, 2004

(30) Foreign Application Priority Data
Apr. 25, 2003 (JP) 2003-121579

(51) Int. Cl. G11B 7/09

(52) U.S. Cl. 369/44.32; 369/53.18; 369/44.25

(57) ABSTRACT

There is disclosed a head positioning control system in which when internal vibration including a frequency component different from a frequency of disturbance such as a higher harmonic occurs by a nonlinear element, the system effectively suppresses the internal vibration. The system has a nonlinear filter 11 to generate a higher wave as an input of an adaptive filter for performing feed forward control.

### CROSS-REFERENCE TO RELATED APPLICATIONS

This application is based upon and claims the benefit of priority from prior Japanese Patent Application No. 2003-121579, filed Apr. 25, 2003, the entire contents of which are incorporated herein by reference.

### BACKGROUND OF THE INVENTION

1. Field of the Invention

The present invention generally relates to disk drives and particularly to head positioning control with disturbance compensation.

2. Description of the Related Art

In recent years, in a field of a disk drive typified by a hard disk drive, against vibration and impact externally applied (generally referred to as disturbance), the application of vibration removal technology and noise canceller technology for canceling noise have been considered.

In a disk drive, a head positioning control system for positioning a head at a target position (target track) on a disk medium is incorporated. In the system, when the influence by disturbance is large, the head positioning accuracy is reduced. Therefore, disturbance compensation technology against external vibration which influences the head positioning accuracy is particularly important to the disk drive.

Generally, in the disk drive, there is employed a feed forward control system which detects disturbance (external vibration) by a disturbance sensor made of an acceleration sensor and suppresses the influence of the disturbance by an adaptive filtering method (for example, refer to U.S. Pat. No. 5,663,847).

Methods as shown in literatures in the prior art are effective in case where vibration transmission characteristics of the disturbance and the disturbance sensor have sufficient linearity. Actually, a mechanical mechanism related to the head or the disk medium is incorporated in the object disk drive of vibration removal. The disk drive, therefore, has some nonlinear element owing to mechanical restrictions such as a hysteresis characteristic of contact friction and limitation in operation range with respect to the above-mentioned mechanism.

In such a disk drive, in the case where disturbance externally excited at a single frequency, for example, is applied, internal vibration by a higher harmonic of an integral multiple of the single frequency may occur inside the disk drive. In other words, inside the drive where a nonlinear element exists, there occurs internal vibration having a frequency component other than the frequency of the disturbance (particularly higher harmonic component). Such internal vibration cannot be suppressed by the methods described in the literatures in the prior art.

### BRIEF SUMMARY OF THE INVENTION

In accordance with one embodiment of the present invention, there is provided a disk drive including facilities to suppress internal vibration having a frequency component other than a frequency of disturbance.

The disk drive comprises a first controller which performs head positioning control under which a head is positioned at a target position on a disk medium by feed back control; an internal sensor which detects a position error of the head in relation to the target position; an external sensor which detects disturbance equivalent to vibration or impact to be externally applied as a signal; and a second controller which calculates and outputs a control compensation value to the first controller according to the disturbance detection signal, the second controller including: a nonlinear filter which executes nonlinear filtering processing with respect to the disturbance detection signal detected by the external sensor; and an adaptive filtering unit which calculates the control compensation value based on the disturbance detection signal processed by the nonlinear filter and the position error detected by the internal sensor and adjusts a filtering parameter according to the disturbance detection signal.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing a fundamental configuration of a head positioning control system according to an embodiment of the present invention.

FIG. 2 is a block diagram showing a configuration of a disk drive according to the present embodiment.

FIG. 3 is a block diagram showing a specific configuration of the head positioning control system according to the present embodiment.

FIG. 4 is a flow chart showing the steps of nonlinear filtering processing for generating a limiter according to the present embodiment.

FIG. 5 is a flow chart showing the steps of nonlinear filtering processing for generating a square wave according to the present embodiment.

FIG. 6 is a flow chart showing the steps of nonlinear filtering processing for generating a half wave according to the present embodiment.

FIG. 7 is a graph for explaining an operation of a nonlinear filter according to the present invention by time domain.

FIG. 8 is a graph for explaining the operation of the nonlinear filter according to the present invention by frequency domain.

FIGS. 9 and 10 are graphs showing position error spectra with respect to the effect of the present embodiment.

FIG. 11 is a graph for explaining the effect of the nonlinear filter according to the present embodiment by time domain.

FIG. 12 is a graph for explaining the effect of the nonlinear filter according to the present embodiment by frequency domain.

### DETAILED DESCRIPTION OF THE INVENTION

Hereinafter, referring to the drawings, one embodiment of the present invention will be described.

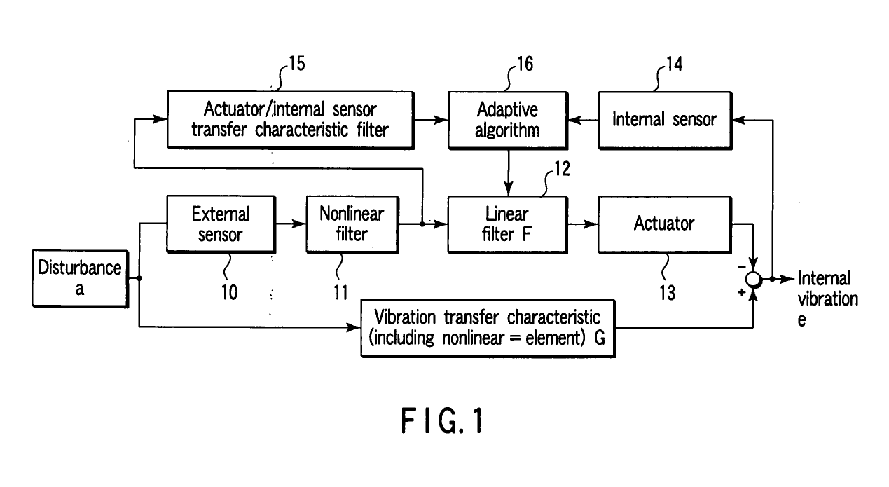

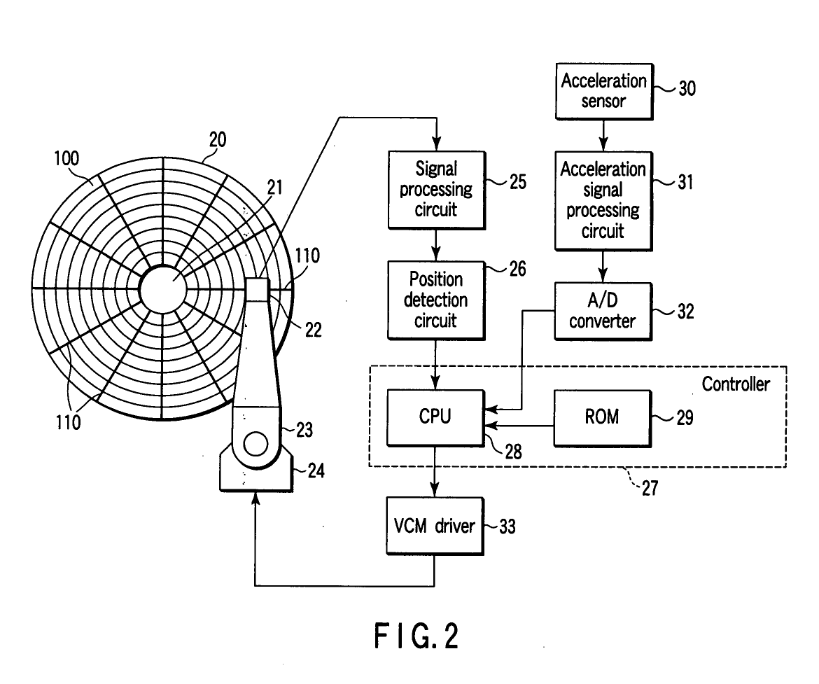

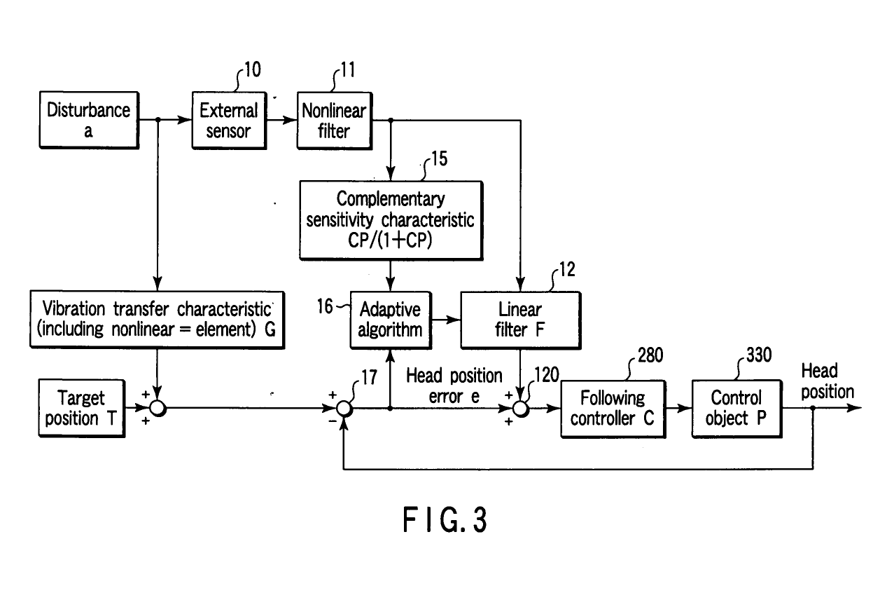

FIG. 1 is a block diagram showing a fundamental configuration of a head positioning control system according to the present embodiment. FIG. 2 is a block diagram showing a configuration of a disk drive according to the present embodiment. FIG. 3 is a block diagram showing a specific configuration of the head positioning control system according to the present embodiment.

### Head Positioning Control System

As shown in FIG. 1, the head positioning control system according to the present embodiment is basically constituted of an external sensor 10, a nonlinear filter 11, a first filter 12, an actuator 13, an internal sensor 14, a second filter 15 and an adaptive algorithm 16.

The external sensor 10 detects disturbance which is vibration or impact to be externally applied (external exciting force a) at predetermined sampling times. The nonlinear filter 11 executes nonlinear filtering processing described later with respect to a disturbance detection signal detected by the external sensor 10.

The first filter 12 is a linear filter (parameter F) which executes adaptive filtering processing together with the adaptive algorithm 16 and simulates a vibration transmission characteristic G including a nonlinear element. The vibration transmission characteristic G is an internal vibration characteristic including the nonlinear element of a mechanism incorporated in the inside of the disk drive (element related to a head or disk medium).

The actuator 13 is an object of head positioning control (plant P), and specifically refers to a voice coil motor (VCM). The internal sensor 14 is a position error detection unit which detects internal vibration occurring inside the driver (specifically, a head position error e). The second filter 15 is a filter which simulates the transfer characteristics of the actuator 13 and the internal sensor 14.

FIG. 3 shows the head positioning control system actually applied to the disk drive. In the system, the internal sensor 14 is a position error detection unit 17 which detects the position error e between a target position T and the position of the head moved by the actuator 13, which is an object of control (plant P) 330.

A following controller (a first controller, transfer characteristic C) 280 determines a control value to drive and control the actuator 13 so as to eliminate the position error e by feed back control. This control value is specifically equivalent to a driving current value of the VCM.

On the other hand, a feed forward control system (second controller) realizes compensation of the disturbance detected by the external sensor 10. The feed forward control system adds a disturbance compensation value from the linear filter 12 to the position error e by an addition unit 120 to output it to the following controller (first controller) 280.

The feed forward control system includes the nonlinear filter 11, the first filter (linear filter) 12, and the second filter 15 having a complementary sensitivity characteristic (CP/(1+CP)). The second filter 15, as described above, is equivalent to the filter which simulates the characteristics of the actuator 13 (330) and the internal sensor 14 (17).

The disturbance detected by the external sensor 10 deforms the disk medium or a case of the drive with the external exciting force a, and is applied to the feed back control system as fluctuation of the target position T. This transfer characteristic is the vibration transfer characteristic G. The object of the present embodiment is to realize a head positioning control system including a feed forward control system which suppresses the influence of the disturbance on the position error e.

### Configuration of Disk Drive

As shown in FIG. 2, the disk drive according to the present embodiment has a mechanism including a disk medium 20 on which servo data and user data are recorded, a spindle motor 21, and a head 22 mounted on an actuator 23, and the head positioning control system (servo system).

The disk medium 20 rotates at a predetermined angular velocity by the spindle motor 21. In the disk medium 20, a number of tracks 100 are formed concentrically. Each of the tracks 100 is provided with servo areas 110 at predetermined intervals. In each of the tracks 100, data areas divided into a plurality of data sectors are formed except for the servo areas 110.

A read head included in the head 22 reads out servo data from the rotating disk medium 20 at predetermined time intervals. The head 22 includes the read head only for reading and a write head only for writing.

The actuator 23 is rotationally driven in a radial direction of the disk medium 20 by driving force of a voice coil motor (VCM) 24. Driving current is supplied from a VCM driver 33 to the VCM 24 so that the VCM 24 is driven and controlled under the control of a CPU 28.

The head positioning control system according to the present embodiment is realized by a signal processing circuit 25, a position detection circuit 26, a controller 27, an acceleration sensor 30, an acceleration signal processing circuit 31, and an A/D converter 32.

The signal processing circuit 25 is a read channel in which servo data or user data read out by the read head of the head 22 is subjected to reproduction-processing (including error correction processing). The position detection circuit 26 detects the position of the head 22 based on the servo data reproduced by the signal processing circuit 25.

The controller 27 is a main element which realizes the head positioning control system shown in FIGS. 1 and 3, and includes the micro processor (CPU) 28 and a memory 29. The memory 29 includes ROM mainly storing a program of the CPU 28, flash EEPROM, and RAM.

In the head positioning control system shown in FIGS. 1 and 3, the CPU 28 realizes the feed back control system (first controller) and the feed forward control system (second controller), excluding the external sensor 10. The CPU 28 calculates the control value for driving and controlling the VCM 24 (plant 330) based on a head position detected at predetermined time intervals.

The acceleration sensor 30 is an element which realizes the external sensor 10, and detects disturbance (vibration or impact) to output it as an analog voltage signal. The acceleration signal processing circuit 31 includes a filter which amplifies the disturbance detection signal from the acceleration sensor 30 to reduce sensor noise. The A/D converter 32 converts the disturbance detection signal (acceleration detection signal) output from the acceleration signal processing circuit 31 to digital data to send it to the CPU 28.

### Head Positioning Control Operation

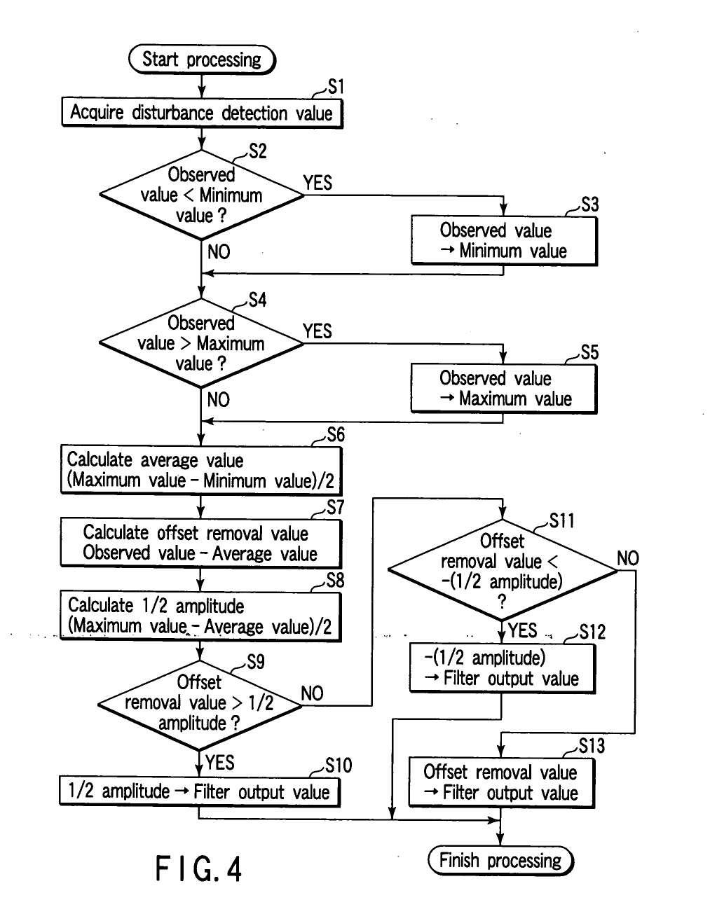

Referring to FIGS. 4 to 12 in addition to FIGS. 1 to 3, the head positioning control operation according to the present embodiment will be explained.

Firstly, in the disk drive, the CPU 28 constitutes a sample value control system which determines the control value of the VCM 24 which is a control object at predetermined time intervals (sampling intervals). That is, the CPU 28 corresponds to the nonlinear filter 11, the first and second filters 12 and 15, and the adaptive algorithm 16 shown in FIGS. 1 and 3. Here, the driving current value supplied to the VCM 24 is limited in advance by the VCM driver 33 from mechanical and electrical limitation.

The acceleration sensor 30 corresponds to the external sensor 10, and detects disturbance at predetermined sampling time intervals. The CPU 28 acquires a digital value of the disturbance detection signal from the A/D converter 32 in synchronization with timing at which a head position detection signal is obtained.

Furthermore, the internal vibration corresponds to the head position error e. The internal sensor 14 corresponds to the position detection circuit 26 and the CPU 28 which calculates the position error e.

Here, in the system having a fundamental configuration as shown in FIG. 1, the operation when the function of the nonlinear filter 11 is excluded will be explained briefly.

When the control is not executed, the disturbance a causes the internal vibration e through the vibration transfer characteristic G. The system detects the disturbance a by the external sensor 10, makes the disturbance go through the linear filter 12 (transfer characteristic F) which simulates the vibration transfer characteristic G, and then executes the control by the actuator 13 to eliminate (suppress) the internal vibration e.

Here, for simplification, if the transfer characteristics of the external sensor 10 and the actuator 13 are expressed as 1, the internal vibration e is expressed by the following formula (1):

e=(G−F)×a (1)

That is, an error between the vibration transfer characteristic G and the transfer characteristic F of the filter 12 influences the internal vibration e. The system, therefore, detects the internal vibration e by the internal sensor 14 to change the transfer characteristic (parameter) F of the filter 12 by the adaptive algorithm 16 so as to eliminate the internal vibration e (approximate 0). The adaptive algorithm 16 makes the disturbance detection signal from the disturbance sensor 10 go through the filter 15 and inputs it together with the internal vibration e.

Here, in the disk drive, the function of the adaptive filter including the adaptive algorithm 16 and the filter 12 is realized by digital filtering processing of the CPU 28. As an example of digital filtering operations realizing the adaptive filter, FIR digital filtering processing will be described.

With a filter order expressed by n and a sampling time expressed by k, a filter output y(k) is expressed by the following formula (2) using a filter coefficient Ri(k) (i=1, . . . n−1), disturbances a(k), a(k−1), . . . a(k−n+1).

y(k)=R0(k)a(k)+R1(k)a(k−1)+. . . Rn−1(k) a(k−n+1) (2)

The adaptive algorithm updates the filter coefficient according to the following formula (3) using the internal vibration e(k).

R0(k+1)=R0(k)+Me(k)a(k)

R1(k+1)=R1(k)+Me(k)a(k−1)

Rn−1(k+1)=Rn−1(k)+Me(k)a(k−n+1) (3)

Here, M represents an adaptive gain, for which a constant number which allows the filter coefficient to converge is selected.

### Nonlinear Filter

With respect to the above-mentioned system, a nonlinear element such as a mechanism in particular is included in the actual disk drive. Therefore, the internal vibration (head position error e) having a frequency component (particularly, higher harmonic) other than a frequency of the disturbance is generated.

The system according to the present embodiment generates the higher harmonic from the disturbance detection signal measured by the external sensor 10 (acceleration sensor 30), using the function of the nonlinear filter 11. The system eliminates the position error e, and executes the control which compensates the disturbance including the higher harmonic to suppress the internal vibration including the higher harmonic.

According to the present embodiment, there is supposed a case where disturbance which is a sinusoidal wave of a single frequency is detected by the acceleration sensor 30 and the internal vibration (position error) e including a higher harmonic of an integral multiple of the disturbance frequency occurs inside the drive. The CPU 28 executes nonlinear filtering processing with respect to the disturbance detection signal from the acceleration sensor 30 (output of the A/D converter 32) to generate any of the following three types of higher harmonics.

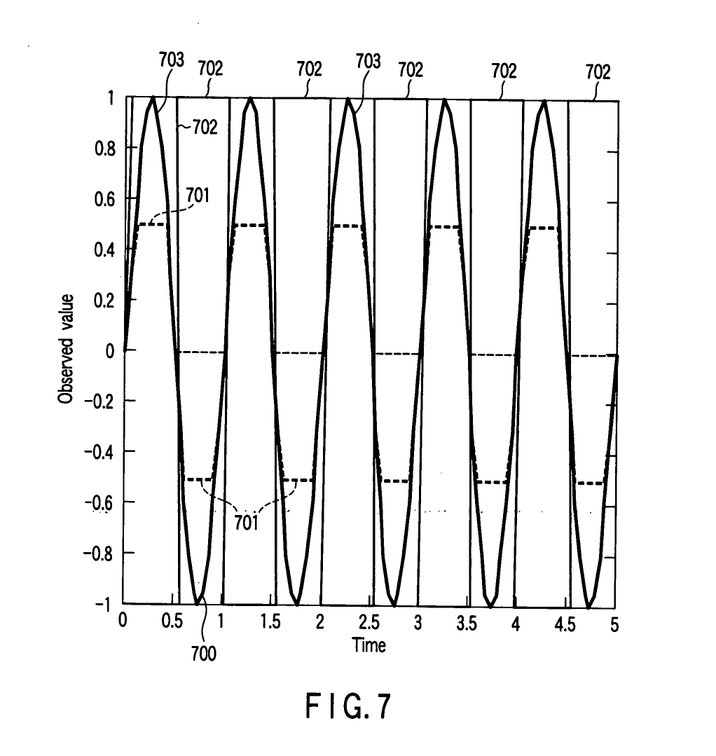

Specifically, as the higher harmonics, a sinusoidal wave whose amplitude peak value is limited (hereinafter referred to as a limiter) 701, a square wave 702, and a half wave sinusoidal wave 703 are supposed in relation to a sinusoidal wave 700, as shown in FIG. 7. Here, FIG. 7 is a graph showing characteristics in an operation of the nonlinear filter 11 (nonlinear filtering processing of the CPU 28) by time domain.

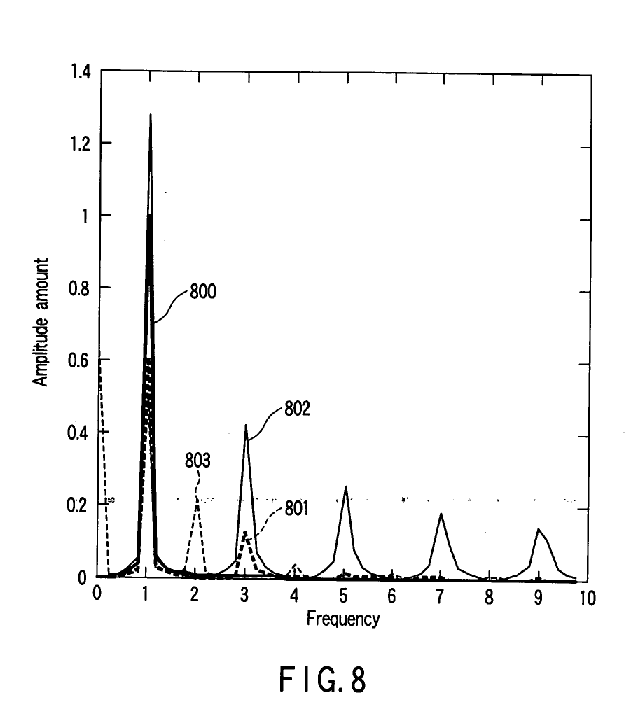

FIG. 8 is a graph showing characteristics in the operation of the nonlinear filter 11 (nonlinear filtering processing of the CPU 28) by frequency domain. That is, FIG. 8 shows a Fourier-transformed disturbance detection signal, and reference numerals 800, 801, 802 and 803 denotes a sinusoidal wave, limiter, square wave and half wave sinusoidal wave, respectively. Here, the limiter 801 and the square wave 802 include an odd-order component. The half wave sinusoidal wave 803 includes an even-order component.

FIGS. 4, 5 and 6 are flow charts showing operation steps every sampling cycle for generating the limiter, square wave and half wave by the nonlinear filtering processing of the CPU 28, respectively.

Firstly, referring to the flowchart of FIG. 4, the operation steps for calculating the limiter will be described. The CPU 28 acquires the disturbance detection signal from the acceleration sensor 30 (step Si). Here, the disturbance detection value by the acceleration sensor 30 is referred to as an observed value. The CPU 28 calculates a minimum value, maximum value, average value, and offset removal value of the observed value (steps S2 to S7). Here, in the case where the observed value is above a previous maximum value or below a previous minimum value, it is recorded as a new maximum or minimum value.

The CPU 28 calculates the average value according to a formula expressed by “(maximum value−minimum value)/2”. In addition, the offset removal value is calculated according to a formula expressed by “observed value−average value”.

Furthermore, as a limit value of a peak value of the limiter 701, for example, a ½ amplitude value is calculated according to (maximum value−average value)/2) (step S8). Here, although the limit value is not necessarily limited to the ½ amplitude in order to realize the limiter, too small a limit value brings about the influence of observed noise easily. In contrast, too large a limit value reduces the higher harmonic component. Accordingly, the limit value is desirably determined according to characteristics of the control object (VCM 24).

Moreover, the CPU 28 compares an absolute value of the offset removal value and the limit value (½ amplitude value), and when the offset removal value is not above the limit value, the offset removal value is set as an output value of the nonlinear filter 11 (No in step S9: S11 to S13). On the other hand, when the offset removal value is above the limit value, the limit value (½ amplitude value) is set as the output value of the nonlinear filter 11 (Yes in step 9: S10).

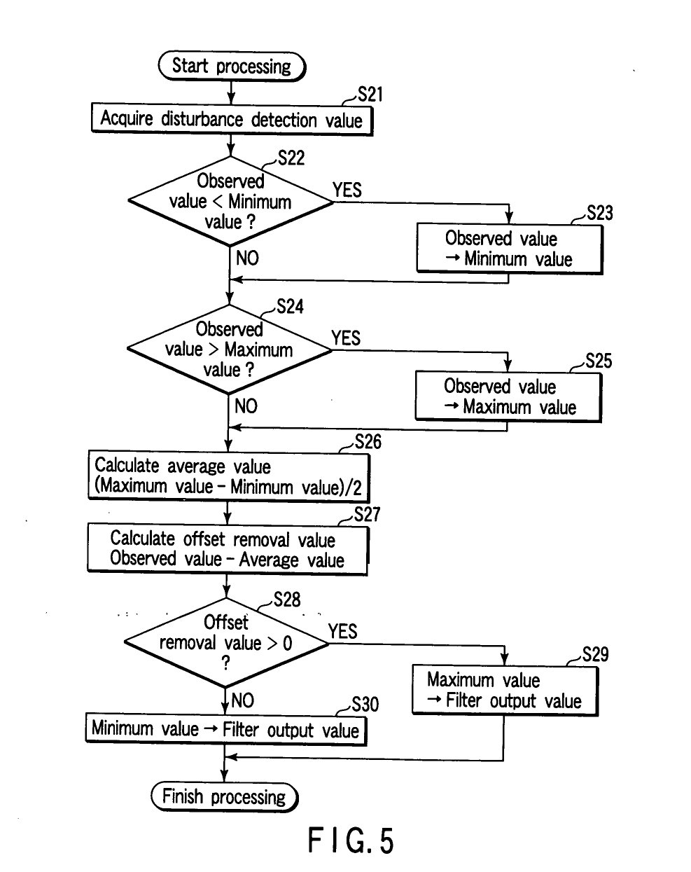

Next, referring to the flow chart of FIG. 5, the operation steps for calculating the square wave will be described.

As in the limiter, the CPU 28 acquires the disturbance detection signal from the acceleration sensor 30 (step S21). The CPU 28 calculates the minimum value, maximum value, average value and offset removal value of the observed value (steps S22 to S27).

Here, in the case of the square wave, the CPU 28 sets the maximum value as the output value of the nonlinear filter 11 when the offset removal value is positive (YES in step S28: S29). On the other hand, when the offset value is negative, the minimum value is set as the output value of the nonlinear filter 11 (NO in step S28: S30).

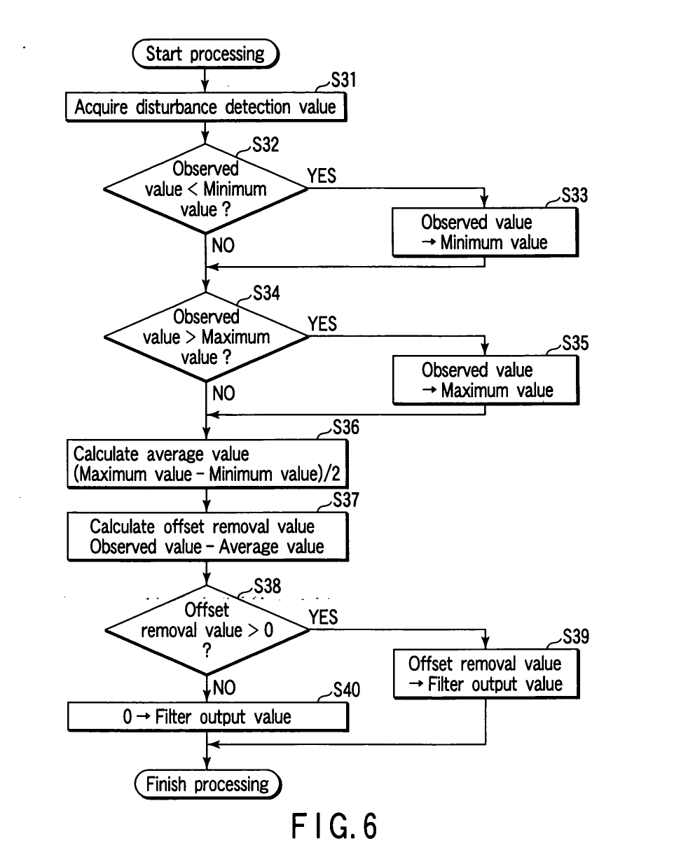

Further, referring to the flow chart of FIG. 6, the operation steps for calculating the half wave sinusoidal wave will be described.

As in the square wave, the CPU 28 acquires the disturbance detection signal from the acceleration sensor 30 (step S31). The CPU 28 calculates the minimum value, maximum value, average value and offset removal value of the observed value (steps S32 to S37).

Here, in the case of the half wave sinusoidal wave, the CPU 28 sets the offset removal value as the output value of the nonlinear filter 11 when the offset removal value is positive (YES in step S38: S39). On the other hand, when the offset value is negative, the output value of the nonlinear filter 11 is set at 0 (NO in step S38: S40).

### Effect of the Present Embodiment

To put it briefly, the disk drive according to the present embodiment, by applying the head positioning control system as shown in FIGS. 2 and 3, the internal vibration (position error e) including the higher harmonic component occurring inside the drive when the disturbance of vibration or impact is applied can be effectively suppressed. In the system, the feed forward control system generates the higher harmonic component such as the limiter, square wave, and half wave from the disturbance detection signal detected from the external sensor 10 (acceleration sensor 30) by the nonlinear filter 11 (nonlinear filtering processing of the CPU 28). By inputting the disturbance compensation value including the higher harmonic component by feed forward in the linear filter 12, the controller 280 (CPU 28) can execute the feed back control so as to eliminate the head position error e having the vibration characteristic by the nonlinear element.

In other words, even when the disturbance fluctuation and the internal vibration by the nonlinear element in the disk drive mechanism occur, the influence on the head position error with respect to the disturbance can be suppressed.

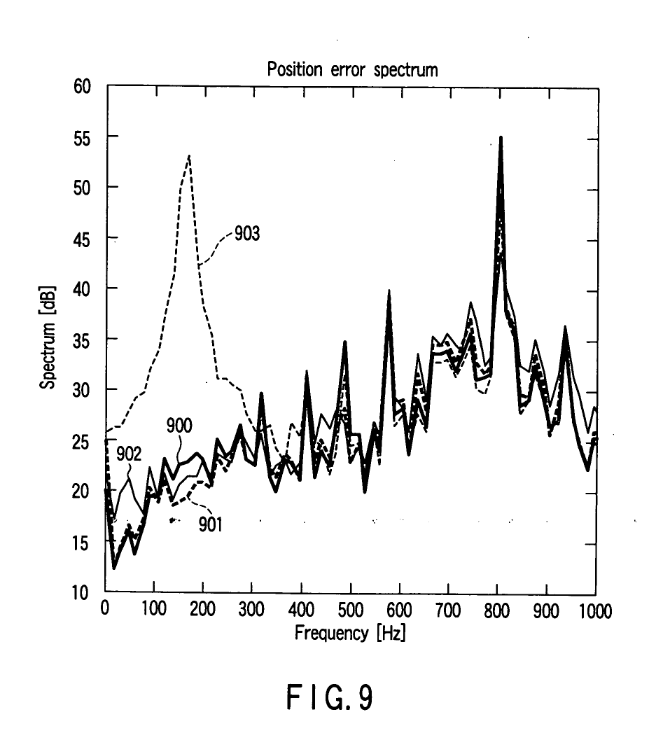

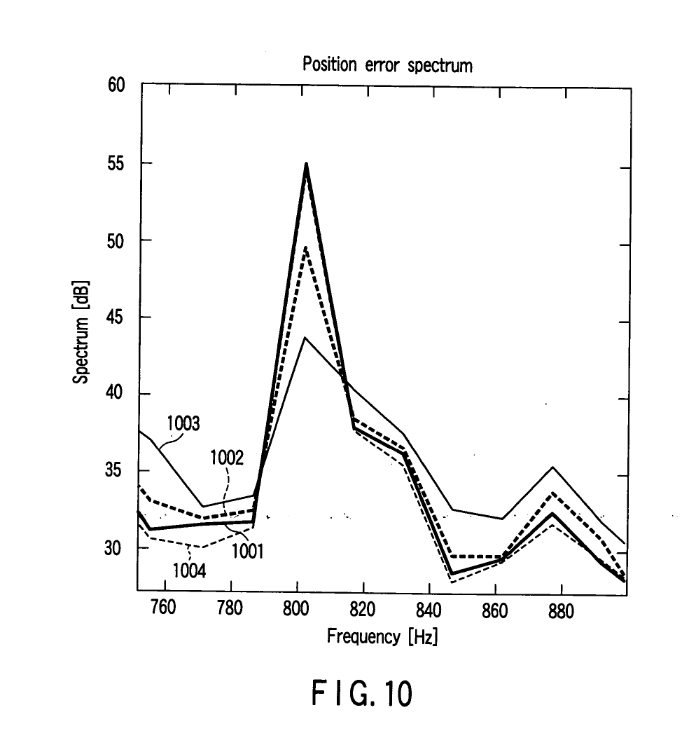

FIGS. 9 and 10 are graphs showing position error spectra with respect to the effect of the system according to the present embodiment. FIG. 9 is a graph showing the general characteristics in the case where disturbance of a frequency 160 Hz is applied. In FIG. 9, reference numeral 900 indicates a case without the nonlinear filter, reference numeral 903 indicates a case where the suppressing control does not function. In addition, reference numerals 901 and 902 indicate cases where when the disturbance of a frequency 160 Hz is applied, a limiter and a square wave which are odd-order higher harmonics are generated, respectively.

Furthermore, FIG. 10 is a graph which is enlarged in the vicinity of 800 Hz when the disturbance of a frequency 160 Hz is applied and higher harmonics of 800 Hz (5 times) occur drastically. In FIG. 10, reference numeral 1001 indicates a case without the nonlinear filter, and reference numeral 1004 indicates a case where the suppressing control does not function. In addition, reference numerals 1002 and 1003 indicate cases where when the disturbance of a frequency 160 Hz is applied, a limiter and a square wave which are odd-order higher harmonics are generated, respectively.

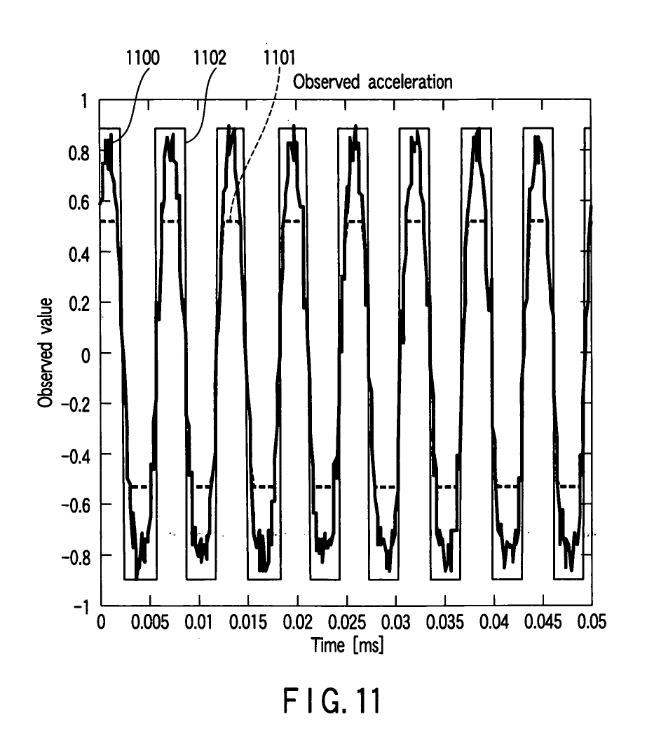

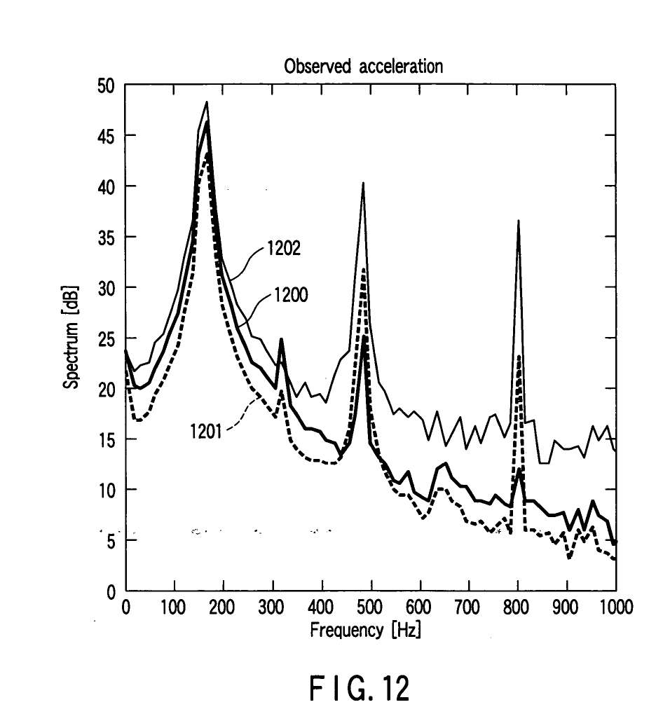

FIGS. 11 and 12 are graphs showing results (output of the nonlinear filter) obtained by the nonlinear filtering processing with respect to observed acceleration (disturbance) by time domain and frequency domain. In FIG. 11, reference numeral 1100 indicates a case without the nonlinear filter. Further, reference numerals 1101 and 1102 indicate cases where, when the disturbance of a frequency 160 Hz is applied, a limiter and a square wave which are odd-order higher harmonics are generated, respectively.

In the observed acceleration (disturbance), a 160 Hz component is prominently large, and a 480 component equivalent to three times of the 160 Hz comes next, while a 800 Hz component equivalent to five times hardly exists. In the conventional method not using the nonlinear filter, although the disturbance frequency component of 160 Hz which can be observed can be suppressed, the higher harmonic component of 800 Hz which cannot be observed has no effect on the improvement of the position error.

On the other hand, the function of the nonlinear filter 11 (nonlinear filtering processing of the CPU 28) increases the odd-order component of the disturbance, thereby generating an acceleration signal interrelated to the higher harmonic component of 800 Hz, at which the position error is large. Accordingly, the adaptive filter operates effectively, thereby improving the position error in the feed back control system. In the comparison between the limiter and the square wave, although a noise component other than the higher harmonic component is largely increased in the square wave, the odd-order component is also increased, as shown in FIG. 12. Therefore, in FIG. 10, it is clear that the square wave is excellent in suppressing rate of the 800 Hz component.

Incidentally, by combining the nonlinear elements of the limiter and the half wave in the nonlinear filter 11 (nonlinear filtering processing of the CPU 28), a case where a plurality of higher harmonics occur can be addressed. In this case, the order of the adaptive filter needs to be increased so as to match the number of the higher harmonic components required to be suppressed.

In short, when the internal vibration including a frequency component different from a frequency of disturbance such as a higher harmonic occurs by a nonlinear element, the internal vibration can be effectively suppressed. Accordingly, the reliable head positioning control can be realized.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A disk drive comprising:
a first controller which performs head positioning control under which a head is positioned at a target position on a disk medium by feed back control;
an internal sensor which detects a position error of the head in relation to the target position;
an external sensor which detects disturbance equivalent to vibration or impact to be externally applied as a signal; and
a second controller which calculates and outputs a control compensation value to the first controller according to the disturbance detection signal, the second controller including:
a nonlinear filter which executes nonlinear filtering processing with respect to the disturbance detection signal detected by the external sensor; and
an adaptive filtering unit which calculates the control compensation value based on the disturbance detection signal processed by the nonlinear filter and the position error detected by the internal sensor, and adjusts a filtering parameter according to the disturbance detection signal.

2. The disk drive according to claim 1, wherein
the external sensor detects the disturbance at predetermined sampling times, and
the second controller includes:
a first filter which calculates the control compensation value at each of the sampling times according to the disturbance detection signal processed by the nonlinear filter;
a unit which combines the output of the first filter and the position error to output the result to the first controller;
a second filter which simulates a closed-loop transfer characteristic of the feed back control; and
an adaptive unit which adjusts the parameter of the first filter based on the disturbance detection signal processed by the nonlinear filter and the second filter and the position error.

3. The disk drive according to claim 1, wherein the nonlinear filter generates the disturbance detection signal including a higher harmonic component from the disturbance detection signal.

4. The disk drive according to claim 1, wherein the nonlinear filter operates as a limiter which limits a maximum amplitude value of the disturbance detection signal.

5. The disk drive according to claim 1, wherein the nonlinear filter generates a square wave signal from the disturbance detection signal.

6. The disk drive according to claim 1, wherein the nonlinear filter generates a half wave signal from the disturbance detection signal.

7. A disk drive comprising:
a head which performs reading and writing of data with respect to a disk medium;
an actuator which mounts the head and moves it in a radial direction of the disk medium;
a position detection unit which detects a position error of the head in relation to a target position on the disk medium;
an acceleration sensor which detects disturbance equivalent to vibration and impact to be externally applied as a signal; and
a controller which controls the actuator to perform positioning control with respect to the head so as to eliminate the position error, wherein
the controller includes the function of executing nonlinear filtering processing with respect to the disturbance detection signal detected by the acceleration sensor, based on the processing result and the position error, executing adaptive filtering processing in which a control compensation value for controlling the disturbance is calculated, and adjusting a parameter of the adaptive filtering processing according to the disturbance detection signal.

8. The disk drive according to claim 7, wherein
the acceleration sensor detects the disturbance at predetermined sampling times, and
the controller combines the position error and the control compensation value calculated at each of the sampling times by the adaptive filtering processing according to the disturbance detection signal obtained by the nonlinear filtering processing to set the result as an input of the positioning control,
the controller including a unit which adjusts the positioning error the parameter of the adaptive filtering processing from the positioning error and the disturbance detection signal subjected to the filtering processing which simulates a closed-loop transfer characteristic of the positioning control, and the nonlinear filtering processing.

9. The disk drive according to claim 7, wherein the controller executes the nonlinear filtering processing to generate the disturbance detection signal including a higher harmonic component from the disturbance detection signal.

10. The disk drive according to claim 7, wherein the controller executes the nonlinear filtering processing to limit a maximum amplitude value of the disturbance detection signal.

11. The disk drive according to claim 7, wherein the controller executes the nonlinear filtering processing to generate a square wave from the disturbance detection signal.

12. The disk drive according to claim 7, wherein the controller executes the nonlinear filtering processing to generate a half wave from the disturbance detection signal.

13. A method of head positioning in a disk drive including a head positioning control system which performs head positioning control under which a head is positioned at a target position on a disk medium by feed back control, and a feed forward control system which calculates a control compensation value with respect to the head positioning control system to input the resultant value, the method comprising:
acquiring a position error of the head in relation to the target position;
acquiring a disturbance detection signal of disturbance equivalent to vibration and impact to be externally applied;
executing nonlinear filtering processing with respect to the disturbance detection signal;
executing adaptive filtering processing in which the control compensation value is calculated based on the position error and the disturbance detection signal processed by the nonlinear filtering processing; and
adjusting a parameter of the adaptive filtering processing according to the disturbance detection signal.

14. A method of head positioning in a disk drive including a head which performs reading or writing of data with respect to a disk medium, an actuator which mounts and moves the head in a radial direction of the disk medium, and a controller which controls the actuator to execute head positioning control, the method comprising:
acquiring a position error of the head in relation to a target position on the disk medium;
acquiring disturbance equivalent to vibration and impact to be externally applied using an acceleration sensor;
executing nonlinear filtering processing with respect to the disturbance detection signal detected by the acceleration sensor;
executing adaptive filtering processing in which a control compensation value for controlling the disturbance is calculated based on the position error and the processing result of the nonlinear filtering processing; and
adjusting a parameter of the adaptive filtering processing according to the disturbance detection signal.
